(19) United States
(12) Patent Application Publication
(10) Pub. No.: US 2008/0226385 A1
(43) Pub. Date: Sep. 18, 2008

(54) Hard cover binders having removably mounted binding mechanism

(76) Inventor: Paul E. Ruble, Fillmore, CA (US)

Correspondence Address: KOPPEL, PATRICK & HEYBL, 555 ST. CHARLES DRIVE, SUITE 107, THOUSAND OAKS, CA, 91360, US

(21) Appl. No.: 12/012,375

(22) Filed: Jan. 31, 2008

Related U.S. Application Data
(60) Provisional application No. 60/898,763, filed on Jan. 31, 2007.

(51) Int. Cl. B42F 13/00; B42F 3/00; B42F 13/26

(52) U.S. Cl. 402/75

(57) ABSTRACT

A printed material binder, comprising a hardcover binder having front and back binder panels that are joined at a spine having and inside and outside surfaces. A binder mechanism is removably mounted to said spine inside surface by a mounting mechanism providing at least one removable connection point between said binding mechanism and said spine. Many different mounting mechanisms can be used including, but not limited to, socket and stud fasteners, string/strap and hole arrangements, clip-in and shank fasteners, and ball and socket fasteners.

The present invention claims the benefit of U.S. Provisional Patent Application Ser. No. 60/898,763 to Ruble, filed on Jan. 31, 2007.

### BACKGROUND OF THE INVENTION

1. Field of the Invention

This invention relates to binders for paper material and the like and more particularly, to hardcover binders having removably mounted binding mechanisms.

2. Description of the Related Art

Many different techniques ranging from paper clips and staples, 3-ring binders, pocket organizers, mechanical binders to a “perfect” binding are used to bind and organize printed materials. 3-ring binders (including D-ring binders) are a popular means of binding and organizing printed material and commonly comprise a binder hardcover and a 3-ring binding mechanism. The binding mechanism is usually affixed to the spine on the inside of the hardcover. These binders are desirable because the 3-ring binding mechanism can be opened and closed during the life of the binder to add or remove printed material.

The useful life of a 3-ring type binder typically ends upon failure of the hardcover or the binding mechanism and often times the hardcover will fail or wear out before the binding mechanism or vice versa. With a failure, the binding mechanism cannot be easily removed from hardcover for recycling and often, both will be damaged during the removal process. Further, additional costs are incurred by transporting the 3-ring binder to the location for separating the two. Upon failure of either, the entire 3-ring type binder is disposed of, wasting the operable portions of the binder. If the binding mechanism could be easily removed, the material from the hardcover (PVC or chipboard) could be recycled and the binding mechanism could be recycled.

A 3-ring binder is typically manufactured at one location and shipped to a retail location for sale to the public. During manufacture, the 3-ring binding mechanism is permanently affixed to a binder hardcover and the binder is shipped as a complete unit. The binders are folded with an empty binding mechanism and stacked in a box. This manner of shipping is inefficient because of the large amount of empty space within the shipping container and results in shipping large boxes with relatively few binders. Often times the binders are manufactured in a foreign country and the amount of space needed to ship a product significantly impacts the overall cost of the product.

This inefficient manner of shipping also limits the amount of product that can be stored at the retail location. A surplus inventory is typically maintained at the retail location and a supply is kept on the retail sales floor. Storage and shelf space are limited at most retail locations and any means of reducing the storage or shelf space needed for a particular product is desirable. The binders are generally stored at the retail location in the same inefficient manner, resulting in a waste of inventory storage space and retail shelf space.

Another disadvantage of the 3-ring type binder is that when it is filled with printed material, the rings can unintentionally open when the binder is jarred. For instance, filled 3-ring binders are often carried in briefcases with the spine to the top and the open end to the bottom. If the briefcase is jarred, the force of the printed material on the rings can cause the rings to open and cause the printed material to fall out of the binder.

Another drawback of conventional 3-ring hardcover binders is the inability to interchange the hardcover with different types of binding mechanisms. If a hardcover is dedicated as a 3-ring binder, the 3-ring binding mechanism is affixed to the hardcover, usually by riveting, and cannot be removed and replaced with another type of binding mechanisms such as plastic comb, spiral, double wire, Vellobind or thermal bind.

U.S. Pat. No. 6,386,784 to Ruble (same inventor as the present application) discloses a hardcover binder that can be interchanged with a variety of binding mechanisms. The hardcover has a pair of interior pockets that are offset from and open towards the hard cover's spine. The invention comes with a pair of inserts that can be perforated and integrated with the binding mechanism. In the case of a 3-ring binding mechanism, the inserts can be affixed to the binding mechanism or the binding mechanism can be mounted on a single section of insert material resulting in two insert flaps that function the same as the inserts. The inserts (or flaps) are removably inserted and fit snugly into the interior pockets to anchor the binding mechanism against the spine and between the hardcover.

### SUMMARY OF THE INVENTION

Binders according to the present invention comprise a hardcover and removably mounted binding mechanism, which can be packaged, shipped and stored separately and mounted together at any point in the trade channel. This allows the binders to take up less space in shipping and storage, which translates into shipping and storage convenience and cost savings. This arrangement also allows the binding mechanism to be removed from the hard cover if it is damaged or if a different type of binding mechanism is desired.

These and other features and advantages of the invention will be apparent to those skilled in the art from the following detailed description of preferred embodiments, taken together with the accompanying drawings, in which:

### BRIEF DESCRIPTION OF THE DRAWINGS

FIGS. 1A through 1D are views of one embodiment of a binding hardcover and a removable 3-ring binding mechanism according to the present invention utilizing a snap arrangement;

FIGS. 2A through 2C are views of another embodiment of a binding hardcover and a removable 3-ring binding mechanism according to the present invention utilizing a string arrangement;

FIGS. 3A through 3F are views of another embodiment of a binding hardcover and a removable 3-ring binding mechanism according to the present invention utilizing a clip type arrangement;

FIGS. 4A through 4F are views of another embodiment of a binding hardcover and a removable 3-ring binding mechanism according to the present invention also utilizing a clip type arrangement; and

FIGS. 5A through 5C are views of another embodiment of a binding hardcover and a removable 3-ring binding mechanism according to the present invention utilizing a ball and socket type arrangement.

### DETAILED DESCRIPTION OF THE INVENTION

The present invention provides a hardcover binder with removable and interchangeable binding mechanisms, with the invention particularly adapted for 3-ring binders. It should, however, be understood that the invention can also be used with many other binding mechanisms such as D-ring, plastic comb, spiral, double wire, Vellobind or thermal bind type binder. In each embodiment, the hard covers have a binding mechanism that is removably mounted to the spine. For the drawings below, the same reference numerals will be used for similar features in the different embodiments.

The present invention is described herein with reference to certain embodiments but it is understood that the invention can be embodied in many different forms and should not be construed as limited to the embodiments set forth herein. In particular, the present invention is described below in regards to certain binders, but can also be applied in other applications.

It is also understood that when an element such as a layer, region or substrate is referred to as being “on” another element, it can be directly on the other element or intervening elements may also be present. Furthermore, relative terms such as “inner”, “outer”, “upper”, “above”, “lower”, “beneath”, and “below”, and similar terms, may be used herein to describe a relationship of one layer or another region. It is understood that these terms are intended to encompass different orientations of the device in addition to the orientation depicted in the figures.

Although the terms first, second, etc. may be used herein to describe various elements or components, these elements or components should not be limited by these terms. These terms are only used to distinguish one element or component from another and thus, a first element or component discussed below could be termed a second element or component without departing from the teachings of the present invention.

Embodiments of the invention are described herein with reference to view illustrations that are schematic illustrations of idealized embodiments of the invention. As such, variations from the shapes of the illustrations as a result, for example, of manufacturing techniques and/or tolerances are expected. Embodiments of the invention should not be construed as limited to the particular shapes illustrated herein but are to include deviations in shapes that result, for example, from manufacturing. A region illustrated or described as square or rectangular will typically have rounded or curved features due to normal manufacturing tolerances. Thus, the regions illustrated in the figures are schematic in nature and their shapes are not intended to illustrate the precise shape of a region of a device and are not intended to limit the scope of the invention. For purposes of illustration and understanding, some of the features of the embodiments below may be shown out of scale in the following figures.

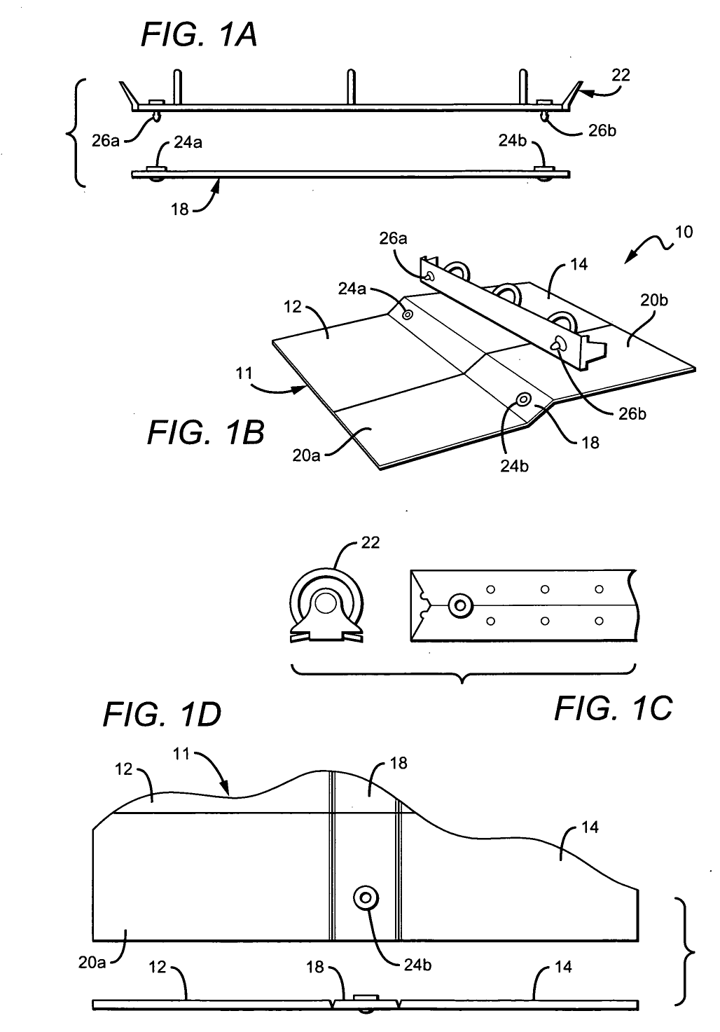

FIGS. 1A through 1D show one embodiment of a binder 10 according to the present invention having a binder hardcover 11 that is suitably manufactured by thermally sealing polyvinyl over chip board or PVC inserts. The hardcover 11 includes rigid front and back panels 12, 14 that are joined along a spine 18. Thermal sealing creates seams 16a and 16b in the polyvinyl that respectively separate the front and back panels from spine 18. As shown, spine 18 can be a soft spine formed only from the polyvinyl or a hard spine heat sealed with a rigid insert inside the polyvinyl. The inserts can be made of many different materials such as chip board or PVC, and as more fully described below, the inserts can comprise part of the mounting mechanism for the binding mechanism.

Spine 18 is conventionally labeled by imprinting the polyvinyl directly or by placing a clear plastic layer over the spine that is thermal sealed along seams 16a and 16b to define a clear sleeve into which labeled insert can be placed, for example, using the self-loading technique described in U.S. Pat. No. 4,681,472. Alternately, seams 16a and 16b can be merged to provide the spine for separating the covers similar to a magazine.

The inside surfaces of the front and back panels 12 and 14 can have interior pockets 20a and 20b that are formed on the interior of the panels by thermal sealing pieces of polyvinyl material that have the same width but not as tall as the front and back panels 12 and 14. The sides and bottom edges of the panels are thermally sealed along the edges of the panels and the reduced height produces an offset from the top of the panels with the opening to the pockets generally provided at the top edge of the pockets 20 and 20b. Although the pockets 20a and 20b are shown having a rectangular shape, the pockets can take many differed shapes and can be sealed to the panels 12 and 14 in many different ways.

Pursuant to the present invention, the three ring binder mechanism 22 can be removably mounted to the inside surface of the spine 18 using a “stud & socket” type snap fastener, although many other fasteners can also be used. The inside surface of the spine 18 includes two sockets 24a, 24b, preferably aligned down the longitudinal axis of the spine 18. The sockets 24a, 24b can be formed on the spine using many different methods, with the preferred method being mounting to the inside surface using rivets or screws, or molding the sockets 24a, 24b as part of the spine 18 insert such as by injection molding. The binding mechanism 22 has two studs 26a, 26b preferably mounted along its longitudinal axis and spaced apart the same distance as the sockets 24a and 24b. The studs 26a, 26b can be mounted to the binding mechanism 22 using many different methods, with suitable methods being press fitting them or threading them into holes in the binder mechanism 22.

The studs 26a, 26b are arranged to be press fit into the sockets 24a, 24b and mate with the sockets to hold the binding mechanism 22 on the inside surface of the spine 18. The mating of the sockets 24a, 24b and studs 26a, 26b can preferably be accomplished by press fitting the studs 26a, 26b into the sockets 24a, 24b and provides a strong enough fit to hold the binding mechanism 22 to the spine 18 under the weight of paper held on the binding mechanism 22. The mating, however, also allows for the binding mechanism 22 to be removed from the spine 18. This allows the binding mechanism 22 to be replaced if it is damaged and allows it to be replaced with a different type or size of binding mechanism.

By providing the binder mechanism 22 and spine 18 with this type of press fit attachment mechanism, the binder mechanism 22 does not need to be mounted to the spine 18 at the factory. Instead, it can be mounted at any point along the trade channel. For example, it can be mounted at the retail location for display, or it can be mounted by the end user who can purchase the binding mechanism 22 and hard cover 11 separately. This type of flexibility allows the binder mechanism 22 to be shipped and stored separate from the hard cover 11. For example, the hard cover 11 can be laid flat in a box or other container, with additional hard covers positioned on top of it in a stack. The corresponding binding mechanisms 22 can be stacked or arranged next to the stacked hard covers 11 or can be stacked or arranged in another box or container. Shipping and storing this way avoids the wasting of space that is associated with shipping fully assembled hard covers 11 and binding mechanisms 22.

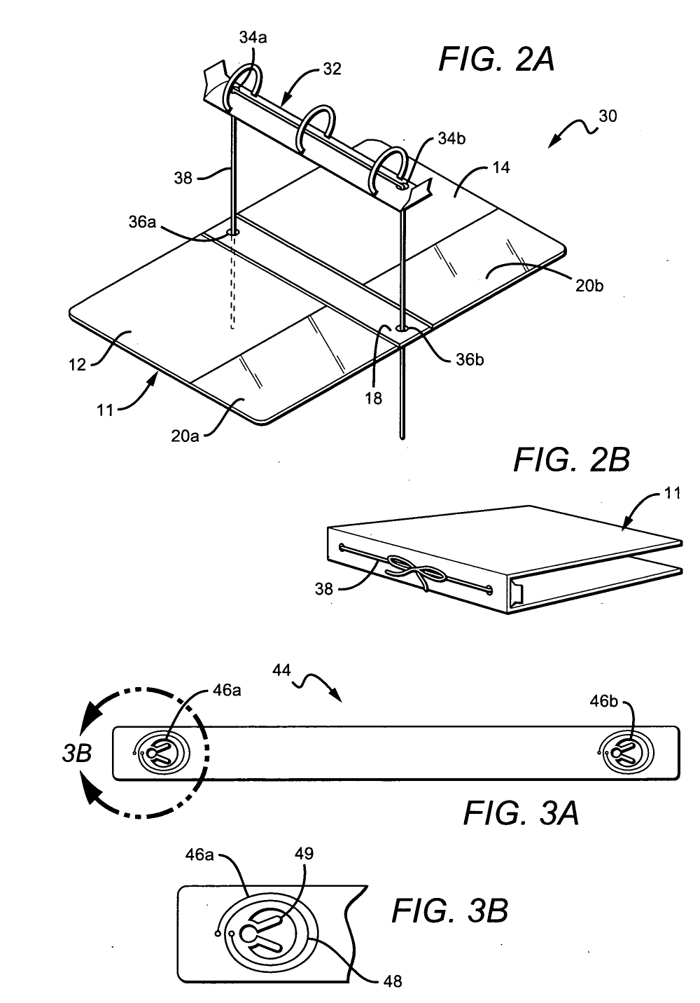

FIGS. 2A through 2C show another embodiment of a binder 30 according to the present invention that is similar to the binder 10 in FIGS. 1A through 1D, and comprises a similar binder hardcover 11 that includes rigid front and back panels 12, 14 that are joined along a spine 18. The inside surfaces of the front and back panels 12 and 14 also have similar interior pockets 20a and 20b that are formed on the interior of the panels by thermal sealing pieces of polyvinyl material that have the same width but not as tall as the front and back panels 12 and 14.

The binder 30 also comprises a binding mechanism 32 that is removably mounted to the spine 18, but uses a different mounting mechanism than binding mechanism 22, described above. Instead of using a stud and socket arrangement, the binding mechanism 32 uses a string or strap type arrangement. The binding mechanism 32 has first and second binding holes 34a, 34b near its ends that are preferably spaced down the binding mechanism's longitudinal axis. The spine 18 has first and second spine holes 36a, 36b that are spaced apart the same distance as binding holes 34a, 34b and are also preferably along the spine's longitudinal axis. When the binding mechanism 32 is placed on the spine 18, the first binding hole 34a is aligned with the first spine hole 36a and the second binding hole 34b is aligned with the second spine hole 36b.

The binding mechanism 32 can be held on the spine by a mechanism that passes through the aligned holes. Many different mechanisms can be used such as straps, belts, or other similar strips of material. In FIGS. 2A through 2C a string 38 is used and runs along the top surface of the binding mechanism 32, with the ends of the string passing through respective aligned holes. The ends of the string 38 are then coupled together on the back side of the spine 18. The string can be coupled together using many different mechanisms such as hooks, snaps, Velcro®, tape or bonding agents such as glue. As shown in FIGS. 2A through 2C, the ends of the string are coupled by knotting them together such that the knot is positioned against the outside surface of the spine 18. In other embodiments according to the present invention, the string or strap can be fed through the aligned holes in the opposite direction with the ends coupled together on the binding mechanism 32 side of the binder 10.

Like the binder 10, the binder 30 also allows for mounting the binding mechanism 32 to the spine 18 at any point in the retail channel. The shipping and storage space can be similarly reduced using the binder 30.

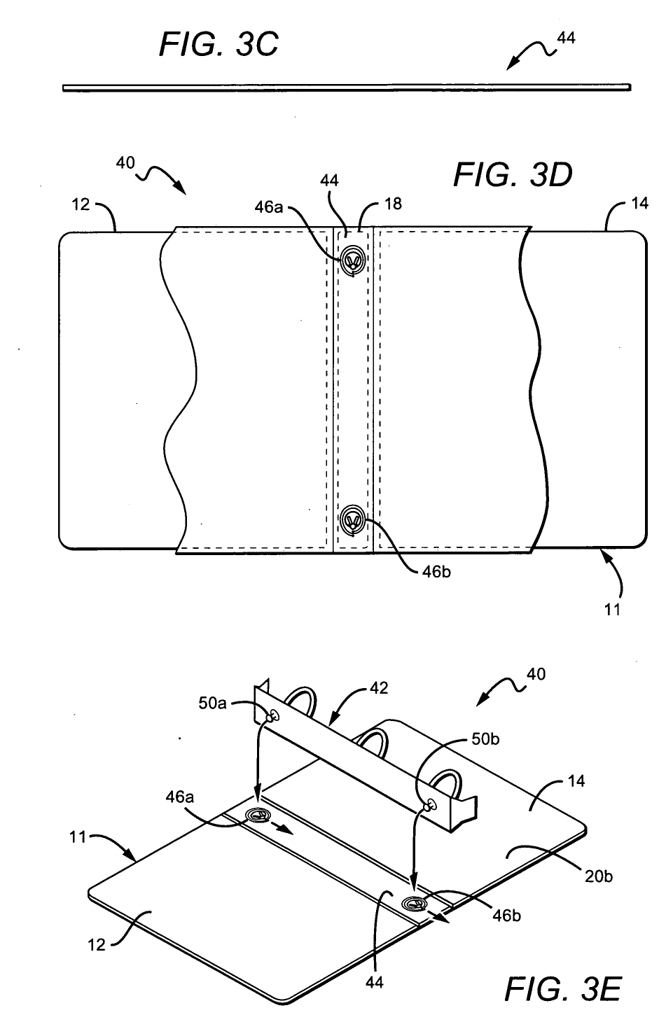

FIGS. 3A through 3F show another embodiment of a binder 40 according to the present invention that is similar to the binder 10 in FIGS. 1A through 1D, and comprises a similar binder hardcover 11 that includes rigid front and back panels 12, 14.

The binder 40 also comprises a binding mechanism 42 and a spine 44 that utilize a different mechanism for mounting the two together. Instead of a stud and socket arrangement, the binder 40 utilizes a “clip-in” arrangement. As shown in FIGS. 3A and 3B, the spine 44 can be injection molded using PVC that is rigid after cooling, with the mold providing first and second clips 46a, 46b, preferably positioned down the spine's longitudinal axis. Each clip 46a, 46b comprises an outside coil portion 48 and a V-shaped fastener portion 49 (shown best in FIG. 3B).

The binding mechanism 42 comprises first and second shanked rivets 50a, 50b, that are spaced apart the same distance as the clips 46a, 46b and are preferably positioned down the binding mechanism's longitudinal axis. Each rivet 50a, 50b is arranged such that its head is directed down to mate with a respective clip 46a, 46b for mounting the binding mechanism 42 to the spine 44. The head of each rivet 50a, 50b is positioned within a respective clip 46a, 46b, in the top of the V-shaped portion 49, and the binding mechanism 42 is slid toward the base of the V-shaped portion 50, until the rivets 50a, 50b are moved to the base of the V-shaped portion. The base of each V-shaped portion is circular and sized to hold the shaft of its respective rivet 50a, 50b. Each rivet 50a, 50b is then held in its clip 46a, 46b, with the head of each rivet positioned between the clip 46a, 46b and the surface of the spine 44. The binding mechanism 42 can be removed from the spine 44 by sliding the binding mechanism the opposite direction, removing the shaft of each rivet 50a, 50b from its V-shaped portion 49.

As best shown in FIG. 3F, the coil portion 48 of each clip 46a, 46b, provides a spring like arrangement between the V-shaped portion 49 and the spine 44 that allows the V-shaped portion to move away from the spine 44 under force, and spring back to the spine when the force is removed. This arrangement is particularly adapted to allowing the binding mechanism 42 to move away from the spine 44 when the binding mechanism 42 is holding paper 52. If the binder 40 is dropped, the coil portion 48 allows each V-shaped portion to move away from the spine under the weight of the paper. As a result, the weight of the paper 52 will not force the rings of the binding mechanism 42 open and allow the paper 52 to fall out of the binding mechanism 42. After the binder is dropped, the coil portion 48 draws the binding mechanism 42 back against the spine 44.

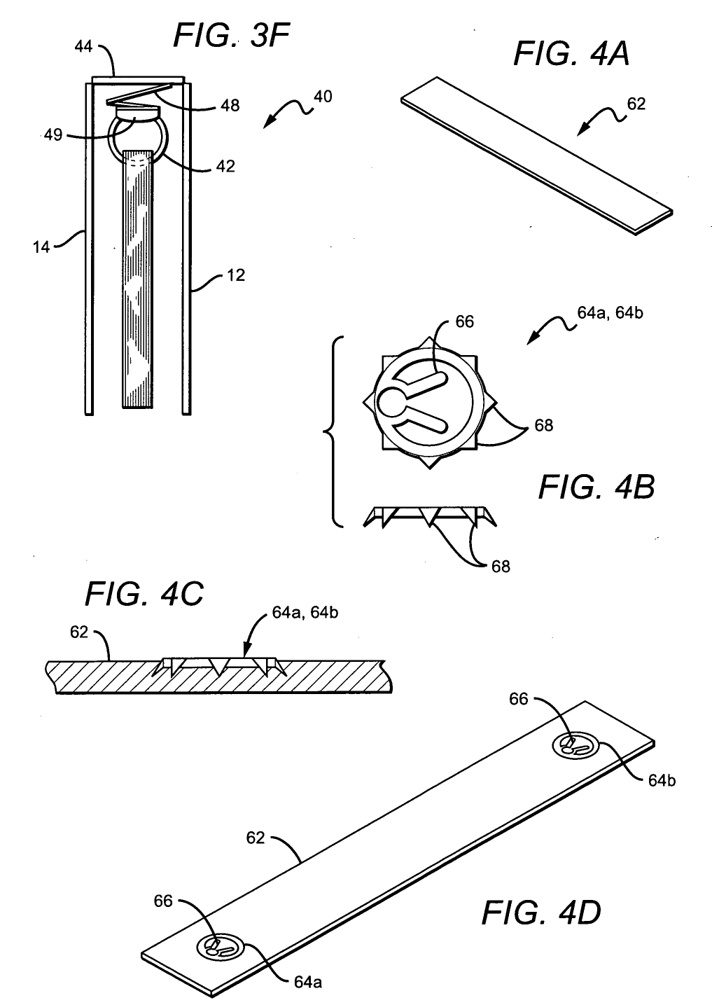

FIGS. 4A through 4F show another embodiment of a binder 60 according to the present invention that is similar to the binder 40 in FIGS. 3A through 3F. The binder 40 comprises a similar binder hardcover 11 that includes rigid front and back panels 12, 14 with the inside surfaces of the front and back panels 12 and 14 having similar interior pockets 20a and 20b. However, instead of having clips injection molded as part of the spine and having a coil portion, the spine 62 is made of chip board and the clips 64a, 64b are manufactured separately from the spine 62. As shown best in FIG. 4B, each clip 64a, 64b comprises a V-shaped portion 66 and a number of barbs 68 around its circumference that are arranged such that the clips 64a, 64b can be mechanically pressed into the spine 62. This can take place during or after manufacturing of the hard cover 11.

The binder 60 also includes a binding mechanism 42 having shanked rivets 50a, 50b. The clips 64a, 64b should be positioned on the spine 62 such that the rivets 50a, 50b can mate with the V-shaped portions 66 to hold the bonding mechanism 42 on the spine 62. For binder 40 and 60, the binding mechanism arrangement allows the binding mechanisms to be shipped separate from the binding hard covers, and to then be removably mounted to the spine of the hard covers.

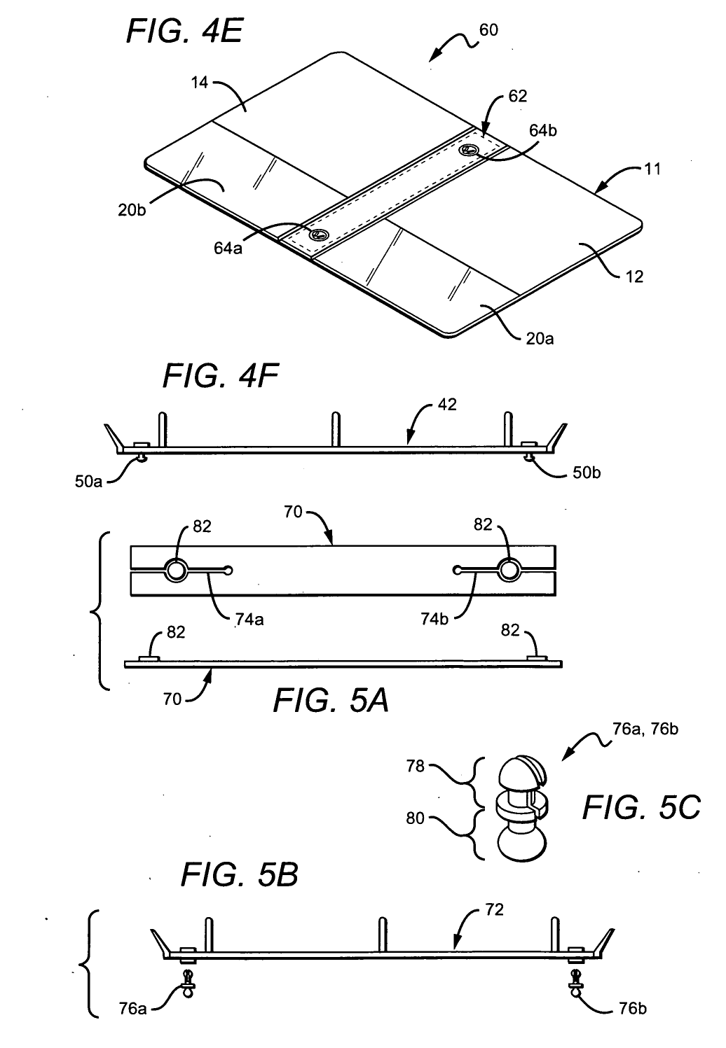

FIGS. 5A through 5C show another embodiment of an injection molded spine 70 and binding mechanism 72 arranged according to the present invention. The spine 70 includes first and second slots 74a, 74b, each of which starts at a respective end and runs partially down the spines longitudinal axis. First and second stud and ball post 76a, 76b are mounted to the binding mechanism 72 preferably along its longitudinal axis, and are spaced to mate with the slots 74a, 74b to hold the binding mechanism 72 to the spine 70.

Each post 74a, 74b can be made of many different materials in different ways, with a suitable post being injection molded from PVC. Each post 74a, 74b has a top section 78 that is slotted to allow each post to pass into a hole in the binding mechanism 72. Each post 74a, 74b also has a bottom section 80 that extends from the binding mechanism 78 toward the spine 70. The slots 74a, 74b each have a respective hole 82 that is sized to hold the shaft of the bottom section 80. When the binding mechanism 72 is mounted to the spine 70, the ball of each lower section is forced through its hole 82, which causes the sections of the spine 70 on the sides of the slots 74a, 74b to flex out until the ball passes through its hole 82. The sides then flex back with each hole 80 around its respective shaft in the bottom section 80. The binding mechanism 72 is held on the spine 70 by the ball on the bottom section 80 of each post 76a, 76b and the binding mechanism can be removed by forcing each post 76a, 76b, out of its slot 74a, 74b.

While several illustrative embodiments of the invention have been shown and described, numerous variations and alternate embodiments will occur to those skilled in the art. Each mounting mechanism can include more than two mounting points and the mounting points can be arranged in different locations. Such variations and alternate embodiments are contemplated, and can be made without departing from the spirit and scope of the invention.

I claim:

1. A printed material binder, comprising:
a hardcover binder having front and back binder panels that are joined at a spine having and inside and outside surface;
a binder mechanism removably mounted to said spine inside surface by a mounting mechanism providing at least one removable connection point between said binding mechanism and said spine.

2. The material binder of claim 1, wherein said mounting mechanism comprises a plurality of sockets on the inside surface of said spine positioned to cooperate with a like plurality of studs on said binding mechanism.

3. The material binder of claim 2, further comprising rivets, wherein said sockets are mounted to said spine by said rivets.

4. The material binder of claim 2, wherein said sockets are injection molded on said spine.

5. The material binder of claim 2, wherein each of said studs is arranged to press-fit into a respective one of said sockets.

6. The material binder of claim 1, wherein said spine comprises a plurality of spine holes and wherein said binder mechanism has a mounting device that cooperates with said holes to removably mount said binding mechanism to said spine.

7. The material binder of claim 6, wherein said mounting mechanism comprises one from the group including string, strap, hooks, snaps, Velcro®, tape and glue.

8. The material binder of claim 1, wherein said mounting mechanism comprises a plurality of clip-in mechanisms arranged to cooperate with a like plurality of shanks.

9. The material binder of claim 8, wherein said clip-in mechanisms are on said spine inside surface and said shanks are on said binding mechanism.

10. The material binder of claim 8, where in each said clip-in mechanisms comprises a V-shaped fastener to cooperate with said shanks.

11. The material binder of claim 10, wherein each of said shanks are press-fit in a respective one of said V-shaped fasteners.

12. The material binder of claim 8, wherein said clip-in mechanisms comprise a coil portion.

13. The material binder of claim 1, wherein said mounting mechanism comprises a ball and socket fastener.

14. The material binder of claim 13, wherein said ball and socket fastener further comprises a plurality of ball and stud posts between said binding mechanism and said spine.

15. The material binder of claim 14, wherein said spine comprises a plurality of slots each arranged to cooperate with a respective one of said ball and stud posts.

16. The material binder of claim 14, wherein said binder mechanism comprises a plurality of holes, each of which is arranged to cooperate with a respective on of said ball and stud posts.
